(19) United States
(12) Patent Application Publication
(10) Pub. No.: US 2014/0177470 A1
(43) Pub. Date: Jun. 26, 2014

(54) Memory Sharing in a Network Device

(71) Applicant: MARVELL WORLD TRADE LTD., St. Michael (BB)

(72) Inventors: Amir Roitshtein, Holon (IL); Gil Levy, Hod Hasharon (IL); Gideon Paul, Modiin (IL)

(73) Assignee: MARVELL WORLD TRADE LTD., St. Michael (BB)

(21) Appl. No.: 14/137,571

(22) Filed: Dec. 20, 2013

Related U.S. Application Data
(60) Provisional application No. 61/740,286, filed on Dec. 20, 2012.

(51) Int. Cl. H04L 12/24; H04L 12/933

(52) U.S. Cl. CPC H04L 41/083; H04L 49/1523
USPC 370/254

(57) ABSTRACT

A network device includes processor devices configured to perform packet processing functions, and a shared memory system including multiple memory blocks. A memory connectivity network couples the processor devices to the shared memory system. A configuration unit configures the memory connectivity network so that processor devices are provided access to respective sets of memory blocks.

### CROSS-REFERENCE TO RELATED APPLICATION

This disclosure claims the benefit of U.S. Provisional Patent Application No. 61/740,286, entitled “Centralized Memory Sharing in a Multi-Processing Unit Switch,” filed on Dec. 20, 2012, which is hereby incorporated by reference herein in its entirety.

### FIELD OF THE DISCLOSURE

The present disclosure relates generally to a processing system that allows multiple processor devices to access respective portions of a shared memory, and more particularly, to network devices such as switches, bridges, routers, etc., that employ such a processing system to process packets.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Some network devices, such as network switches, bridges, routers, etc., employ multiple packet processing elements to simultaneously process multiple packets to provide high throughput. For example, a network device may utilize parallel packet processing in which multiple packet processing elements simultaneously and in parallel perform processing of different packets. In other network devices, a pipeline architecture employs sequentially arranged packet processing elements such that different packet processing elements in the pipeline may be processing different packets at a given time.

### SUMMARY

In one embodiment, a network device comprises a plurality of processor devices configured to perform packet processing functions. The network device also comprises a shared memory system including a plurality of memory blocks, each memory block corresponding to a respective portion of the shared memory system, and each memory block having a respective size less than a total size of the shared memory system. The network device further comprises a memory connectivity network to couple the plurality of processor devices to the shared memory system, and a configuration unit to configure the memory connectivity network so that processor devices among the plurality of processor devices are provided access to respective sets of memory blocks among the plurality of memory blocks.

In another embodiment, a method includes determining memory requirements of a plurality of processor devices of a network device, the plurality of processors devices for performing packet processing functions on packets received from a network. The method also includes assigning, in the network device, memory blocks of a shared memory system to processor devices among the plurality of processor devices based on the determined memory requirements of respective processor devices, each memory block corresponding to a respective portion of the shared memory system, and each memory block having a respective size less than a total size of the shared memory system. Additionally, the method includes configuring, in the network device, a memory connectivity network that couples the plurality of processor devices to the shared memory system so that processor devices among the plurality of processor devices are provided access to respective assigned sets of memory blocks among the plurality of memory blocks.

### BRIEF DESCRIPTION OF THE DRAWINGS

FIG. 1 is a block diagram of an example network device that allows multiple processor devices to access respective portions of a shared memory, according to an embodiment.

FIG. 2A is a diagram of an example hierarchical Clos network that is utilized with the network device of FIG. 1, according to an embodiment.

FIG. 2B is a diagram of a Benes network that is utilized in the hierarchical Clos network of FIG. 2A, according to an embodiment.

FIG. 2C is a diagram of another Benes network that is utilized in the hierarchical Clos network of FIG. 2A and in the Benes network of FIG. 2B, according to an embodiment.

FIG. 3 is a diagram of memory superblock that is utilized with the network device of FIG. 1, according to an embodiment.

FIG. 4 is a flow diagram of an example method for initializing a shared memory system of the network device of FIG. 1, according to an embodiment.

FIG. 5 is a block diagram of another example network device that allows multiple processor devices to access respective portions of a shared memory, according to an embodiment.

FIG. 6 is a block diagram of another example network device that allows multiple processor devices to access respective portions of a shared memory, according to an embodiment.

### DETAILED DESCRIPTION

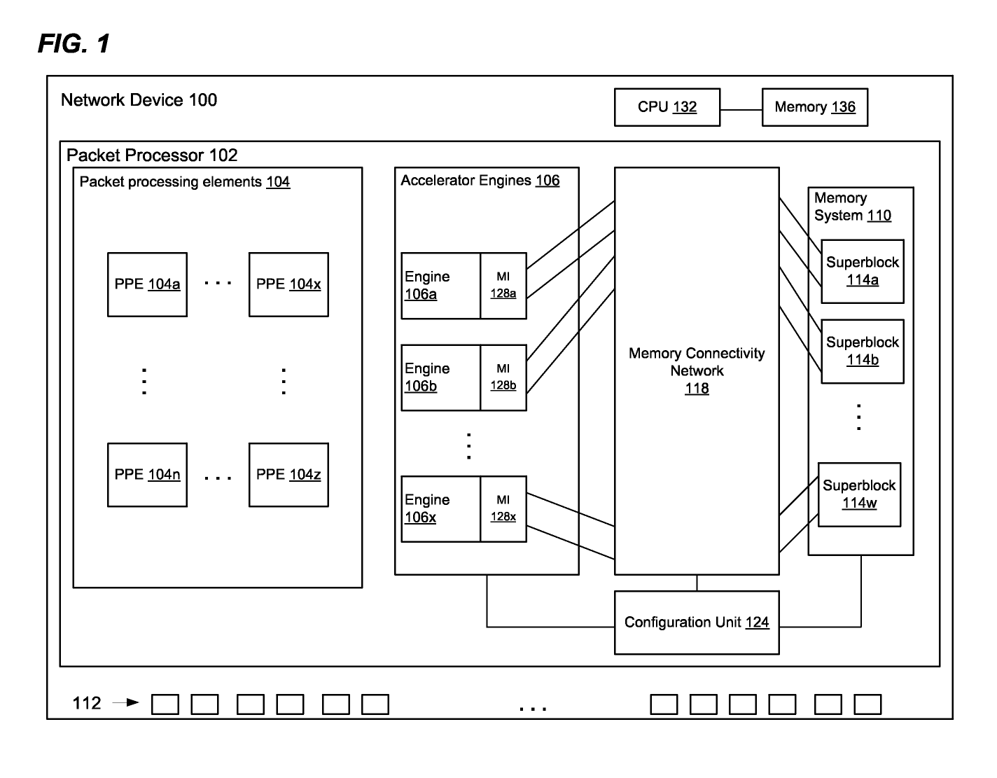

FIG. 1 is a simplified block diagram of an example network device 100 that allows multiple processor devices to access respective portions of a shared memory, according to an embodiment. The network device 100 is generally a computer networking device that connects two or more computer systems, network segments, subnets, and so on. For example, the network device 100 is a switch, in one embodiment. It is noted, however, that the network device 100 is not necessarily limited to a particular protocol layer or to a particular networking technology (e.g., Ethernet). For instance, in other embodiments, the network device 100 is a bridge, a router, a VPN concentrator, etc.

The network device 100 includes a network processor (or a packet processor) 102, and the network processor 102, in turn, includes a plurality of packet processing elements (PPEs), or packet processing nodes (PPNs), 104, and a plurality of external processing engines 106, and a processing controller (not shown in order to simplify the figure) coupled between the PPEs 104 and the external processing engines 106. In an embodiment, the processing controller permits the PPEs 104 to offload processing tasks to the external processing engines 106.

The network device 100 also includes a plurality of network ports 112 coupled to the network processor 102, and each of the network ports 112 is coupled via a respective communication link to a communication network and/or to another suitable network device within a communication network. Generally speaking, the network processor 102 is configured to process packets received via ingress ports 112, to determine respective egress ports 112 via which the packets are to be transmitted, and to cause the packets to be transmitted via the determined egress ports 112. In some embodiments, the network processor 102 processes packet descriptors associated with the packets rather than processing the packets themselves. A packet descriptor includes some information from the packet, such as some or all of the header information of the packet, and/or includes information generated for the packet by the network device 100, in an embodiment. In some embodiments, the packet descriptor includes other information as well such as an indicator of where the packet is stored in a memory associated with the network device 100. For ease of explanation, the term “packet” herein is used to refer to a packet itself or to a packet descriptor associated with the packet. Further, as used herein, the term “packet processing elements (PPEs)” and the term “packet processing nodes (PPNs)” are used interchangeably to refer to processing units configured to perform packet processing operations on packets received by the network device 100.

In an embodiment, the network processor 102 is configured to distribute processing of packets received via the ports 112 to available PPEs 104. The PPEs 104 are configured to concurrently, in parallel, perform processing of respective packets, and each PPE 104 is generally configured to perform at least two different processing operations on the packets, in an embodiment. According to an embodiment, the PPEs 104 are configured to process packets using computer readable instructions stored in a non-transitory memory (not shown), and each PPE 104 is configured to perform all necessary processing (run to completion processing) of a packet. The external processing engines 106, on the other hand, are implemented using one or more application-specific integrated circuits (ASICs) or other hardware components, and each external processing engine 106 is dedicated to performing a single, typically processing intensive operation, in an embodiment. As just an example, in an example embodiment, a first external processing engine 106 (e.g., the engine 106a) is a forwarding lookup engine, a second external processing engine 106 (e.g., the engine 106b) is a policy lookup engine, a third external processing engine 106 (e.g., the engine 106x) is a cyclic redundancy check (CRC) calculation engine, etc.

During processing of the packets, the PPEs 104 are configured to selectively engage the external processing engines 106 for performing the particular processing operations on the packets. In at least some embodiments, the PPEs 104 are configured to perform processing operations that are different than the particular processing operations that the external processing engines 106 are configured to perform. For example, the PPEs 104 perform less resource intensive operations such as extracting information contained in packets (e.g., in packet headers), performing calculations on packets, modifying packet headers based on results from lookup operations not performed by the PPE 104, etc., in various embodiments. The particular processing operations that the external processing engines 106 are configured to perform are typically highly resource intensive and/or would require a relatively longer time to be performed if the operations were performed using a more generalized processor, such as a PPE 104, in at least some embodiments and/or scenarios. For example, the engines 106 are configured to perform operations such as using header data extracted by a PPE 104 to perform a lookup in a forwarding database (FDB), performing a longest prefix match (LPM) operation using an IP address extracted by a PPE 104 and based on an LPM table, etc., in various embodiments. In at least some embodiments and scenarios, it would take significantly longer (e.g., twice as long, ten times as long, 100 times as long, etc.) for a PPE 104 to perform a processing operation that an external processing engine 106 is configured to perform. As such, the external processing engines 106 assist PPEs 104 by accelerating at least some processing operations that would take a long time to be performed by the PPEs 104, in at least some embodiments and/or scenarios. Accordingly, the external processing engines 106 are sometimes referred to herein as “accelerator engines.” The PPEs 104 are configured to utilize the results of the processing operations performed by the external processing engines 106 for further processing of the packets, for example to determine certain actions, such as forwarding actions, policy control actions, etc., to be taken with respect to the packets, in an embodiment. For example, a PPE 104 uses results of an FDB lookup by an engine 106 to indicate a particular port to which a packet is to be forwarded, in an embodiment. As another example, a PPE 104 uses results of an LPM lookup by an engine 106 to change a next hop address in the packet, in an embodiment.

The external processing engines 106 utilize a shared memory system 110 that includes a plurality of memory blocks 114 (sometimes referred to herein as “superblocks”). In some embodiments, each of at least some of the external processing engines 106 is assigned a respective set of one or more memory blocks 114 in the shared memory system 110. As an illustrative example, external processing engine 106a is assigned memory block 114a, whereas external processing engine 106b is assigned memory block 114b and memory block 114c (not shown). In some embodiments, the assignment of memory blocks 114 is transparent to at least a portion of an external processing engine 106. For example, in some embodiments, from the standpoint of at least a portion of an external processing engine 106, it may appear that the external processing engine 106 has a dedicated memory, rather than only a particular portion of a shared memory.

The external processing engines 106 are communicatively coupled to the shared memory system 110 via a memory connectivity network 118. In some embodiments, the memory connectivity network 118 provides for simultaneous access by multiple external processing engines 106 of multiple memory blocks 114. In other words, a memory access made by external processing engine 106a will not be blocked by a simultaneous memory access made by external processing engine 106b, at least in some embodiments.

In some embodiments, the memory connectivity network 118 comprises a Clos network such as a Benes network. A Clos network has three stages: an ingress stage, a middle stage, and an egress stage. Each stage of the Clos network includes one or more 2×2 Clos switches. An input to an ingress Clos switch can be routed through any of the available middle stage Clos switches, to the relevant egress Clos switch. A middle stage Clos is available to route half the bandwidth while the ingress and egress Clos are extending the bandwidth by ×2. In some embodiments, the memory connectivity network 118 comprises a hierarchical Clos network, which is described below. In other embodiments, the memory connectivity network 118 comprises another suitable connectively network such as a crossbar switch, a non-blocking minimal spanning switch, a banyan switch, a fat tree network, etc.

A configuration unit 124 is coupled to the memory connectivity network 118. The configuration unit 124 configures the memory connectivity network 118 so that each of at least some of the external processing engines 106 can access the respective set of one or more memory blocks 114 in the shared memory system 110 assigned to the external processing engine 106. As an illustrative example, the configuration unit 124 configures the memory connectivity network 118 so that external processing engine 106a can access memory block 114a and external processing engine 106b can access memory block 114b and memory block 114c (not shown). Configuration of the memory connectivity network 118 will be described in more detail below.

The configuration unit 124 is also coupled to a plurality of memory interfaces 128, each memory interface 128 corresponding to a respective external processing engine 106. In some embodiments, each memory interface 128 is included in the respective external processing engine 106. In other embodiments, each memory interface 128 is separate from and coupled to the respective external processing engine 106.

The memory interfaces 128 virtualize the memory system 110 with respect to the external processing engines 106 to make the allocation of blocks 114 to various external processing engines 106 transparent to the external processing engines 106, in some embodiments. For example, each memory interface 128 receives first addresses from the corresponding external processing engine 106 corresponding to memory read and memory write operations, and translates the first addresses to second addresses within the one or more blocks 114 assigned to the external processing engine, in some embodiments. The memory interface 128 also translates the first addresses to one or more block identifiers (IDs) that indicate one or more blocks 114 assigned to the external processing engine 106, in some embodiments. In some embodiments, each external processing engines 106 sees a first contiguous address space. This first address space maps to one or more respective address spaces in one or more memory blocks 114 according to a mapping, in some embodiments. For example, if the first address space is too big for a single memory block 114, the first address space may be mapped to multiple second address spaces corresponding to multiple memory blocks 114, in an embodiment. For example, a first portion of the first address space may be mapped to addresses of a first memory block 114, and a second portion of the first address space may be mapped to addresses of a second memory block 114, in an embodiment. Thus, in some embodiments, each memory interface 128 translates first addresses to second addresses (and to memory block IDs, in some embodiments) according to a mapping between the first address space and one or more corresponding second address spaces of one or memory blocks 114.

For a particular memory access operation, the memory interface 128 provides the second address to the memory connectivity network 118, which then routes the translated address to the appropriate memory block 114, in some embodiments. In some embodiments, the memory interface 128 also provides the determined memory block ID to the memory connectivity network 118, and the memory connectivity network 118 uses the memory block ID to route the translated address to the appropriate memory block 114. In other embodiments, the memory connectivity network 118 does not use the memory block ID to route the translated address to the appropriate memory block 114, but rather memory blocks 114 to which the translated address is routed use the accompanying memory block ID to determine if the memory block 114 is to handle the memory access request associated with the second address.

In some embodiments, each memory interface 128 is configured to measure a corresponding latency between the memory interface 128 and each memory block 114 to which the corresponding external processing engine 106 is assigned. The measured latencies are provided to the configuration unit 124, in an embodiment. The measured latencies are additionally or alternatively provided to the memory system 110 (e.g., through the memory connectivity network 118, via the configuration unit 124, etc.), in an embodiment. For example, as discussed below, memory blocks 114 of the memory system 110 include respective delay lines that are utilized to help balance the system to, for example, help prevent collisions between memory access responses travelling back to the engines 106 via the memory connectivity network 118, in some embodiments. In some embodiments, the measured latencies are utilized to configure the delay lines.

In an embodiment, each memory interface 128 is configured to send a respective read request to each memory block 114 to which the corresponding external processing engine 106 is assigned via the memory connectivity network 118. The memory interface 128 is also configured to measure a respective amount of time (e.g., a latency) between when the respective read request was sent and when a respective response is received at the memory interface 128. The measured latencies are then utilized to configure the delay lines. For example, in an embodiment, a delay line of a first memory block 114 assigned to an engine 106 is configured to provide a delay equal to a difference between i) a longest latency between the engine 106 and all memory blocks 114 assigned to the engine, and ii) the latency corresponding to the first memory block 114. Thus, in an embodiment, a delay line of a first memory block 114 assigned to an engine 106 having a longest associated latency will be configured to have a shortest delay (e.g., no delay), whereas a delay line of a second memory block 114 assigned to the engine 106 will be configured to have a delay longer than the shortest delay (e.g., greater than no delay).

In some embodiments, one or more memory blocks 114 (e.g., all of the memory block s 114) do not include configurable delay lines, and one or more memory interfaces 128 (e.g., all of the memory interfaces 128) are not configured to measure latencies such as described above.

In some embodiments, the network device includes a processor 132 that executes machine readable instructions stored in a memory device 136 included in, or coupled to, the processor 132. In some embodiments, the processor 132 comprises a central processing unit (CPU). The processor 132 performs functions associated with initialization and/or configuration of one or more of i) the memory connectivity network 118, ii) the memory interfaces 128, and iii) the memory system 110, in various embodiments. In an embodiment, a portion of the configuration unit 124 is implemented by the processor 132. In an embodiment, the entire configuration unit 124 is implemented by the processor 132. In some embodiments, the processor 132 does not perform any functions associated with initialization and/or configuration of any of i) the memory connectivity network 118, ii) the memory interfaces 128, and iii) the memory system 110.

In some embodiments, the processor 132 is coupled to the memory system 110 and can write to and/or read from the memory system 110. In an embodiment, the processor 132 is coupled to the memory system 110 via a memory interface (not shown) separate from a memory interface via which the memory connectivity network 118 is coupled to the memory system 110.

In operation, and after the i) the memory connectivity network 118, ii) the memory interfaces 128, and iii) the memory system 110 are initialized and configured, when an external processing engine 106 generates a memory access request (e.g., a write request or a read request) with an associated first address, the corresponding memory interface 128 translates the first address to a second address within a memory block 114 assigned to the external processing engine 106. In some embodiments, the corresponding memory interface 128 also translates the first address to a memory block ID of the memory block 114 that corresponds to the second address. For example, if multiple memory blocks 114 have been assigned to the external processing engine 106, the memory interface 128 translates the first address to i) a memory block ID corresponding to the appropriate one of the multiple memory blocks 114, and ii) a second address within the one memory block 114, in some embodiments.

The memory access request and the associated second address (and, in some embodiments, the associated memory block ID) are then provided to the memory connectivity network 118. The memory connectivity network 118 routes the memory access request and the associated second address (and, in some embodiments, the associated memory block ID) to one or more memory blocks 114 assigned to the external processing engine 106. In an embodiment, when multiple memory blocks 114 are assigned to the external processing engine 106, the multiple memory blocks 114 analyze the memory block ID associated with the memory access request to determine whether to handle the memory access request. In another embodiment, the memory connectivity network 118 routes the memory access request only to a single memory block 114, and thus the single memory block 114 does not need to analyze the memory block ID associated with the memory access request to determine whether to handle the memory access request.

The appropriate memory block 114 then handles the memory access request. For example, the appropriate memory block 114 uses the second address to perform the requested memory access request. For a write request, the appropriate memory block 114 writes a value associated with the write request to a memory location in the memory block 114 corresponding to the second address. Similarly, for a read request, the appropriate memory block 114 reads a value from a memory location in the memory block 114 corresponding to the second address. If a response to the memory access request is to be returned to the external processing engine 106 (e.g., a confirmation of a write request, a value read from the memory block 114 in response to a read request, etc.), the memory block 114 provides the response to the memory connectivity network 118, which routes the response back to the external processing engine 106, in an embodiment.

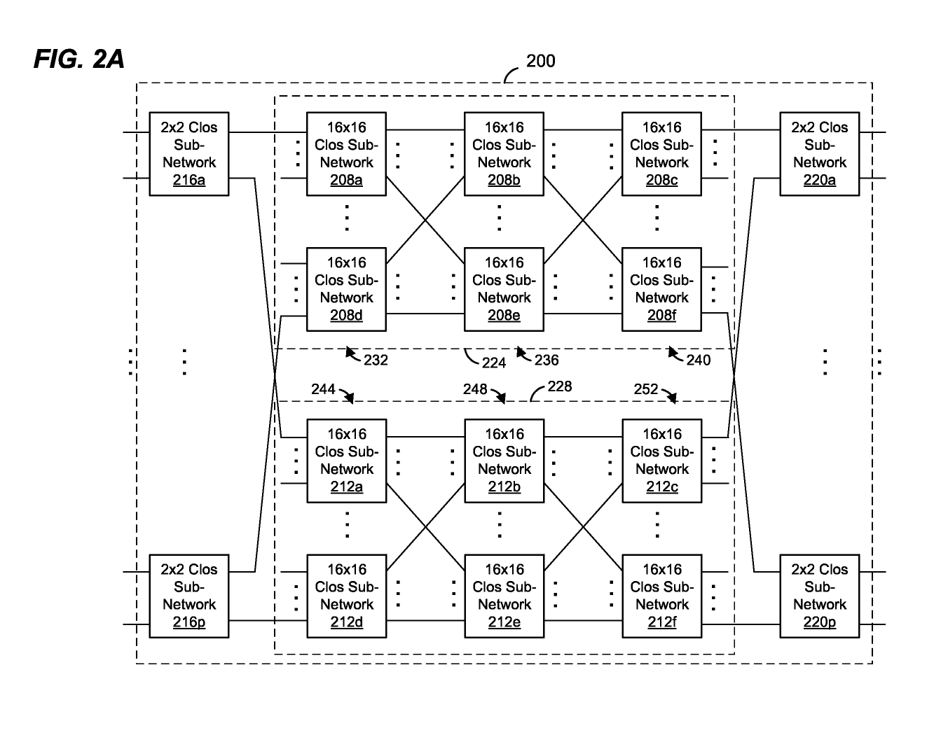

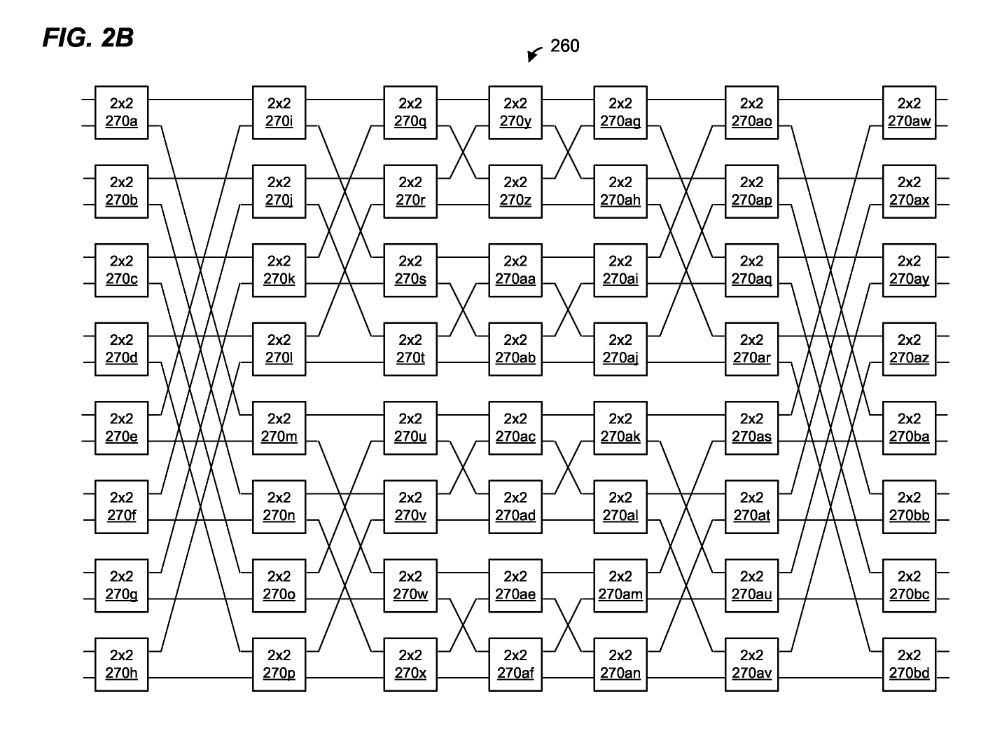

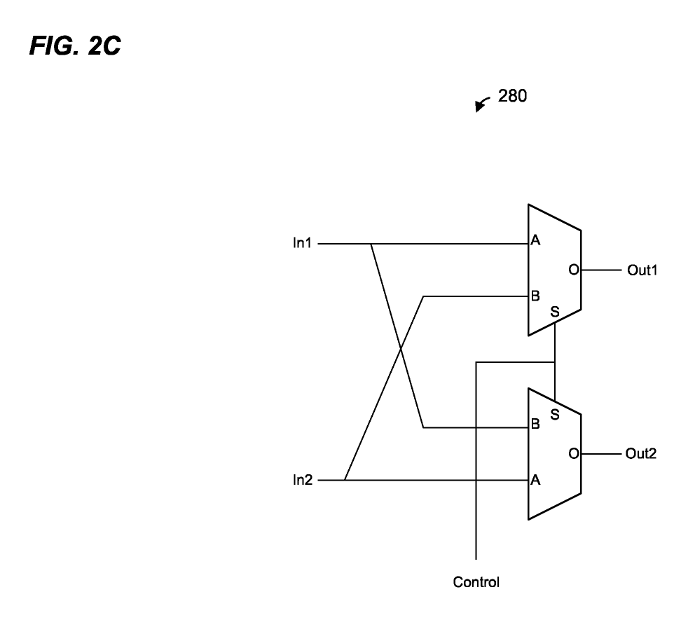

FIG. 2A is a block diagram of an example memory connectivity network 200 that is utilized as the memory connectivity network 118 in the network device 100 of FIG. 1, in some embodiments. For illustrative purposes, the example memory connectivity network 200 is discussed with reference to the network device 100 of FIG. 1. In other embodiments, however, the memory connectivity network 200 is utilized in a suitable network device different than the example network device 100 of FIG. 1.

The memory connectivity network 200 is an example of a hierarchical Clos network. For example, a first hierarchy level includes standard 16×16 Clos networks 208, 212, and standard 2×2 Clos networks 216, 220. Each 16×16 Clos network 208, 212 includes 16 inputs and 16 outputs. Each 2×2 Clos network 216, 220 includes two inputs and two outputs.

The 16×16 Clos networks 208 are arranged and interconnected to form a 256×256 Clos network 224. Similarly, the 16×16 Clos networks 212 are arranged and interconnected to form a 256×256 Clos network 228. The Clos networks 224, 228 correspond to a second hierarchy level. The Clos network 224 includes 256 inputs and 256 outputs. Similarly, the Clos network 228 includes 256 inputs and 256 outputs. In an embodiment, the Clos network 224 has the same structure as the Clos network 228. Each Clos network 224, 228 is itself a hierarchical Clos network, with the 16×16 Clos networks 208, 212 corresponding to a first hierarchy level, and each Clos network 224, 228 corresponding to a second hierarchy level.

The Clos network 224 comprises 16 rows and three columns of the 16×16 Clos networks 208. A respective output of each network 208 in a first column 232 is coupled to an input of a respective network 208 in a second column 236. Thus, the outputs of each network 208 in the first column 232 are coupled to all of the networks 208 in the second column 236. Similarly, a respective output of each network 208 in the second column 236 is coupled to an input of a respective network 208 in a third column 240. Thus, the outputs of each network 208 in the second column 236 are coupled to all of the networks 208 in the third column 240.

Similarly, the Clos network 228 comprises 16 rows and three columns of the 16×16 Clos networks 212. A respective output of each network 212 in a first column 244 is coupled to an input of a respective network 212 in a second column 248. Thus, the outputs of each network 212 in the first column 244 are coupled to all of the networks 212 in the second column 248. Similarly, a respective output of each network 212 in the second column 248 is coupled to an input of a respective network 212 in a third column 252. Thus, the outputs of each network 212 in the second column 248 are coupled to all of the networks 212 in the third column 252.

Inputs of the respective Clos networks 216 correspond to the inputs of the hierarchical Clos network 200. Similarly, outputs of the Clos networks 220 correspond to the outputs of the hierarchical Clos network 200. A respective first output of each Clos network 216 is coupled to a respective input of the Clos network 224, and a respective second output of each Clos network 216 is coupled to a respective input of the Clos network 228. Similarly, a respective first input of each Clos network 220 is coupled to a respective output of the Clos network 224, and a respective second input of each Clos network 220 is coupled to a respective output of the Clos network 228.

Clos networks in hierarchical Clos network at levels lower than the highest hierarchy level (e.g., level three) of the hierarchical Clos network are sometime referred to herein as sub-networks. For example, each of the 16×16 Clos networks 208, 212, and each of the 2×2 Clos networks 216, 220 are sub-networks of the hierarchical Clos network 200. Similarly, each Clos network 224, 228 is a sub-network of the hierarchical Clos network 200. Also, each Clos network 208 is a sub-network of the hierarchical Clos network 224, and each Clos network 212 is a sub-network of the hierarchical Clos network 228.

FIG. 2B is a diagram of one of a 16×16 Clos network 260 that is used as each of the 16×16 Clos networks 208, 212 of FIG. 2A, according to an embodiment. The 16×16 Clos network 260 includes a plurality of 2×2 Clos 270 interconnected as shown in FIG. 2B. The 16×16 Clos network 260 is a Benes network. Generally, an N×N Benes network has a total of 2*log₂ N−1 stages (columns in FIG. 2B), each stage including N/2 2×2 Clos. For example, 16×16 Clos network 260 includes seven columns (stages), each column including eight 2×2 Clos element.

FIG. 2C is a diagram of a 2×2 Clos network 280 that is used as each of the 2×2 Clos networks 216, 220 of FIG. 2A, and each of the 2×2 Clos 270 in FIG. 2B, according to an embodiment. The 2×2 Clos network 280 includes two multiplexers interconnected as shown in FIG. 2C. The multiplexers are controlled by a control signal. The 2×2 Clos network 280 has two states: i) a pass-through state in which input In1 is passed to output Out1 and input In2 is passed to output Out2, and ii) a cross-over state in which In1 is passed to Out2 and In2 is passed to Out1. The control signal selects the state of the 2×2 Clos network 280.

Referring again to FIG. 2A, the 512×512 hierarchical Clos network 200 provides one or more of the following differences over a standard Clos network, at least according to some embodiments. For example, the 512×512 hierarchical Clos network 200 can be operated at a double clock speed to provide the same or similar connectivity of a 1024×1024 Benes network running at 1× clock speed. The 512×512 hierarchical Clos network 200 can be implemented on an integrated circuit (IC) using less IC area as compared to a standard 512×512 Clos network, according to some embodiments. For example, the 512×512 hierarchical Clos network 200 allows at least some stages of the network 200 to be spaced more closely together, in an embodiment. For example, connections between outer stages of a standard Clos network have much more line crossovers as compared to connections between outer stages of the hierarchical Clos network 200. Because such line crossovers take up IC area and power, the hierarchical Clos network 200 requires less IC area overall. The 512×512 hierarchical Clos network 200 can operate at a higher speed as compared to a standard 512×512 Clos network, according to some embodiments. For example, because the stages can be spaced more closely, the lengths of connections between the Clos units are shorter allowing higher speed operation. The 512×512 hierarchical Clos network 200 can be implemented on an integrated circuit (IC) with less complexity and less routing as compared to a standard 512×512 Clos network, according to some embodiments. The 512×512 hierarchical Clos network 200 is more easily scalable as compared to a standard 512×512 Clos network, according to some embodiments. For example, the hierarchy of the design allows building the network 200 from relative small blocks, which enables the layout implementation to optimize the area and wires length efficiently, in some embodiments. Similarly, the hierarchy of the design allows for more straightforward scalability and modularity, in some embodiments. On the other hand, a large flat design of a standard Clos network is very complex which take design tools a very long running time to converge, and any small change to the design will require such tools to start their analysis from the beginning.

The 512×512 hierarchical Clos network 200 uses less power as compared to a standard 512×512 Clos network, according to some embodiments. For example, power of an IC circuit is often proportional to the area of the circuit, so the smaller area of the network 200 results in lower power. Similarly, because shorter connections between stages are required, and lower number of connections, there is less capacitance which also results in lower power (P=F*C*V²), at least in some embodiments.

Each standard subnetwork 208, 212, 216, 220 in the hierarchical Clos network 200 comprises a plurality of multiplexers interconnected in a known manner, in an embodiments. Thus, configuration of the hierarchical Clos network 200 comprises configuring the pluralities of multiplexers, in an embodiment.

Although the hierarchical Clos network 200 includes 512 inputs and 512 outputs, other hierarchical Clos networks of other suitable sizes may be used, such as 1024×1024, 256×256, 128×18, etc., in other embodiments.

Referring again to FIG. 1, the memory system 110 includes more than one type of memory block 114, in some embodiments. For example, the memory system 110 includes memory blocks 114 of different sizes, in some embodiments. For instance, in some embodiments, a memory block 114 of a first size may provide higher access speeds as compared to a memory block 114 of a second size which is larger than the first size. Thus, in some embodiments, engines 106 are assigned memory blocks 114 with size and/or speed characteristics that are suitable to the particular. In other embodiments, each memory block 114 has the same size and/or access speed characteristics.

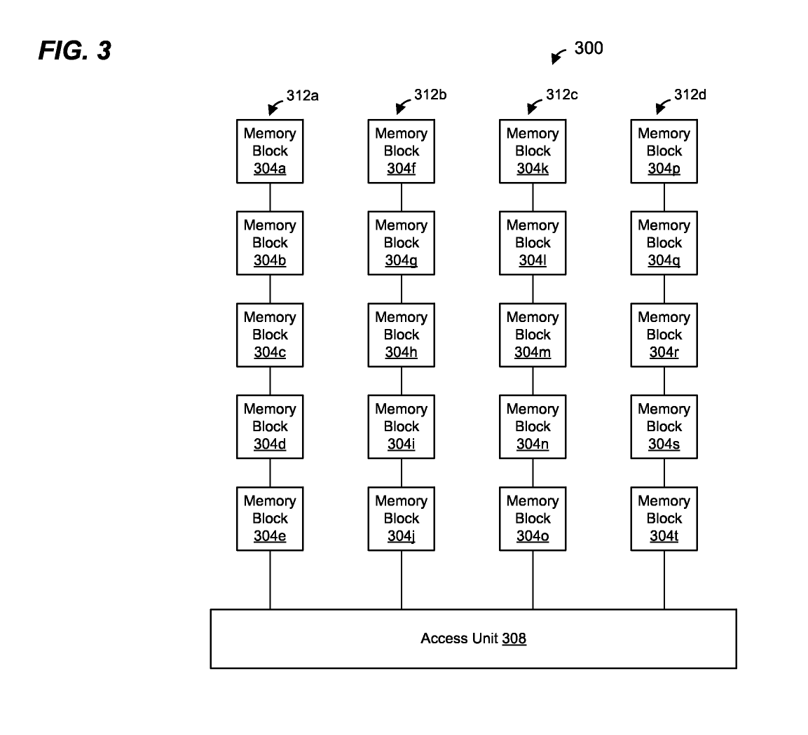

FIG. 3 is a block diagram of an example memory superblock 300 that is utilized as one of the memory superblocks 114 in the network device 100 of FIG. 1, in some embodiments. For illustrative purposes, the example memory superblock 300 is discussed with reference to the network device 100 of FIG. 1. In some embodiments, however, the memory superblock 300 is utilized in a suitable network device different than the example network device 100 of FIG. 1.

The memory superblock 300 includes a plurality of memory blocks 304 arranged in groups 312. The groups 312 of memory blocks 304 are coupled to an access unit 308. The access unit 308 is configured to handle memory access requests from engines 106 received via the memory connectivity network 118. In an embodiment, the memory superblock 300 is associated with a particular superblock ID, and the access unit 308 is configured to respond to memory access requests that include or are associated with the particular superblock ID. Thus, in some embodiments, when the memory superblock 300 receives a memory access request, the memory superblock 300 handles the memory access request when the memory access request includes or is associated with the superblock ID to which the memory superblock 300 corresponds, but ignores the memory access request when the memory access request includes or is associated with a superblock ID to which the memory superblock 300 does not correspond. In other embodiments in which the memory connectivity network 118 routes memory access requests only to the particular superblock 114 that is to handle the memory access request, the memory superblock 300 handles each memory access request that the memory superblock 300 receives.

In an embodiment, the access unit 308 handles a read request by i) reading data from a location in one of the memory blocks 304 indicated by an address associated with the read request, and ii) returning the data read from the location in one of the memory blocks 304 to the engine 106 assigned to the memory superblock 300 by way of the memory connectivity network 118. In an embodiment, the access unit 308 handles a write request by writing data (the data associated with the write request) to a location in one of the memory blocks 304 indicated by an address associated with the write request. In an embodiment, the access unit 308 handles a write request by also sending a confirmation of the write operation to the engine 106 assigned to the memory superblock 300 by way of the memory connectivity network 118.

In some embodiments, the access unit 308 is configured to perform power saving operations in connection with the superblock 300. For example, in an embodiment, if not all of the memory blocks 304 will be used by the engine 106 assigned to the superblock 300, the access unit 308 is configured to shut down (e.g., shut off power to) one or more memory blocks 304 that will not be used by the engine 106. In an embodiment, the access unit 308 is configured to shut down (e.g., shut off power to) one or more groups 312 of memory blocks that will not be used by the engine 106. In some embodiments, if not all of the memory blocks 304 will be used by the engine 106 assigned to the superblock 300, the access unit 308 is configured to gate a clock to (e.g., stop the clock from reaching) one or more memory blocks 304 that will not be used by the engine 106. In an embodiment, the access unit 308 is configured to gate a clock to (e.g., stop the clock from reaching) one or more groups 312 of memory blocks that will not be used by the engine 106.

In some embodiments, the access unit 308 includes a configurable delay line (not shown). The amount of delay provided by the delay line is configurable, in an embodiment. The delay line is used to delay returning a response to an engine 106, in some embodiments. In other embodiments, the delay line is used to delay handling of a memory access request from an engine 106. Delay lines of multiple superblocks 300 in the memory system 110 are utilized to help balance the system to, for example, help prevent collisions between memory access responses travelling back to the engines 106 via the memory connectivity network 118, in some embodiments.

In some embodiments, the superblock 300 is configurable to provide higher bandwidth at the expense of less available memory and vice versa, i.e., the superblock 300 is configurable to provide more memory at the expense of bandwidth. For example, in some embodiments, the superblock 300 can operate in a first mode in which all of the memory blocks 304 are available for storing data, and can also operate in a second mode in which some of the memory blocks 304 are used for storing parity information and thus are not available for storing data. The first mode provides for a maximum available memory size, whereas the second mode provides for higher bandwidth but a smaller available memory size. For example, in an embodiment, the second mode of operation utilizes techniques described in U.S. Pat. No. 8,514,651, which is incorporated by reference herein. For instance, if a read request is made to a memory block, e.g., memory block 304a, that is busy in connection with another memory access request, the requested data in the memory block 304a can be generated by accessing data in one or more other memory blocks, e.g., memory block 304f, and parity data stored in another memory block, e.g., memory block 304p. Thus, instead of waiting until the memory block 304a is no longer busy, the requested data stored in the memory block 304a can be generated using parity data, increasing the bandwidth of operation of the superblock 300. In other embodiments, other suitable techniques permit the superblock 300 to operate in a first mode providing more available memory size but less bandwidth, or in a second mode providing more bandwidth with less available memory size.

In some embodiments, the memory system 110 includes superblocks of different sizes and types. For example, in some embodiments, some of the memory superblocks 114 have a structure the same as the memory superblock 300, whereas other memory superblocks 114 have a structure similar to the memory superblock 300, but including more or less memory blocks 304 and/or more or less groups 312. For example, in some embodiments, some of the memory superblocks 114 have a structure the same as the memory superblock 300, whereas other memory superblocks 114 have a structure similar to the memory superblock 300, but including less memory blocks 304 in each group 312. In some embodiments, some of the memory superblocks 114 have a structure the same as the memory superblock 300, whereas other memory superblocks 114 have a structure similar to the memory superblock 300, but including more memory blocks 304 in each group 312. In some embodiments, some of the memory superblocks 114 have a structure the same as the memory superblock 300, whereas other memory superblocks 114 have a structure similar to the memory superblock 300, but including less groups 312. In some embodiments, some of the memory superblocks 114 have a structure the same as the memory superblock 300, whereas other memory superblocks 114 have a structure similar to the memory superblock 300, but including more groups 312.

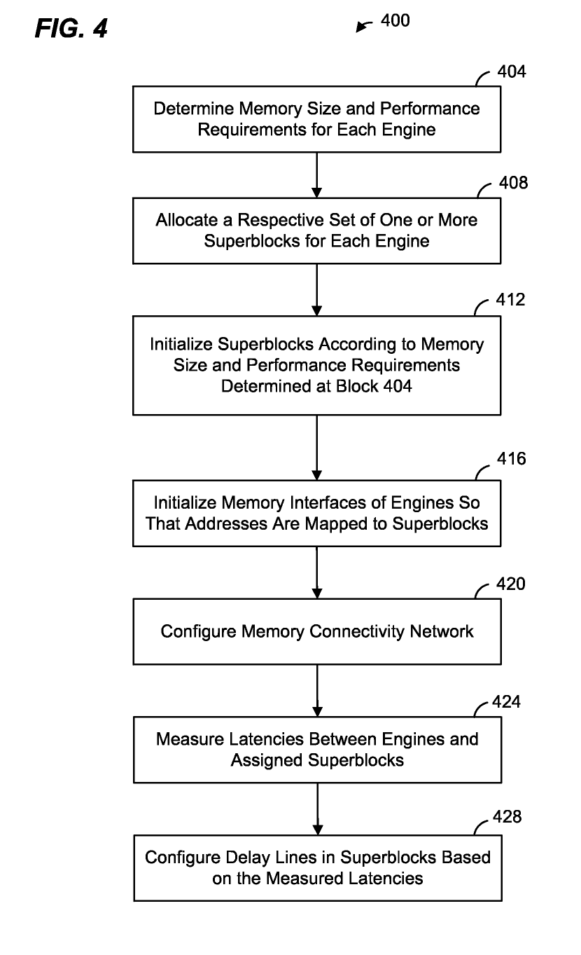

FIG. 4 is a flow diagram of an example method 400 for initializing a memory system of a network device, the memory system including a memory connectivity network such as the memory connectivity network 118 of FIG. 1, according to an embodiment. The method 400 is implemented by the network device 100 of FIG. 1, in an embodiment, and the method 400 is described with reference to FIG. 1 for illustrative purposes. In other embodiments, however, the method 400 is implemented by another suitable network device.

At block 404, memory size and performance requirements for each engine 106 among at least a subset of the engines 106 are determined. For example, the engine 106a maintains a forwarding database, and the forwarding database has a memory size requirement, an access speed requirement, etc., in an embodiment. As another example, the engine 106b is associated with a longest prefix matching (LPM) function and maintains an LPM table, and the LPM table has a memory size requirement, an access speed requirement, etc., in an embodiment.

At block 408, a respective set of one or more superblocks 114 are allocated for each engine 106 among the at least the subset of engines 106 based on the memory size and performance requirements determined at block 404.

At block 412, the superblocks 114 are initialized according to the memory size and performance requirements determined at block 404. For example, if not all of a superblock 114 will be needed, the superblock 114 is initialized to keep an unneeded portion of the superblock 114 powered down, and/or a clock is not gated to the unneeded portion, in an embodiment. As another example, if the superblock 114 is configurable to provide a bandwidth vs. size tradeoff, the superblock 114 is appropriately configured to provide either the greater memory size or the greater bandwidth.

At block 416, memory interfaces 128 of the at least the subset of engines 106 are initialized so that the memory interfaces 128 will map addresses generated by the engines 106 to the assigned superblocks 114 and memory spaces within the superblocks 114.

At block 420, the memory connectivity network 118 is configured so that memory access requests generated by each engine 106 among the at least the subset of engines 106 is routed to the assigned set of one or more superblocks 114.

At block 424, the memory interfaces 128 of the at least the subset of engines 106 measure latencies to the assigned respective sets of one or more superblocks.

At block 428, delays lines in the assigned superblocks are configured based on the latencies measured at block 424 in order to balance the memory system to prevent collisions of memory access responses being routed back to the engines 106.

In some embodiments, blocks 424 and 428 are omitted.

In some embodiments, FIG. 4 is implemented by the CPU 132 and/or the configuration unit 124.

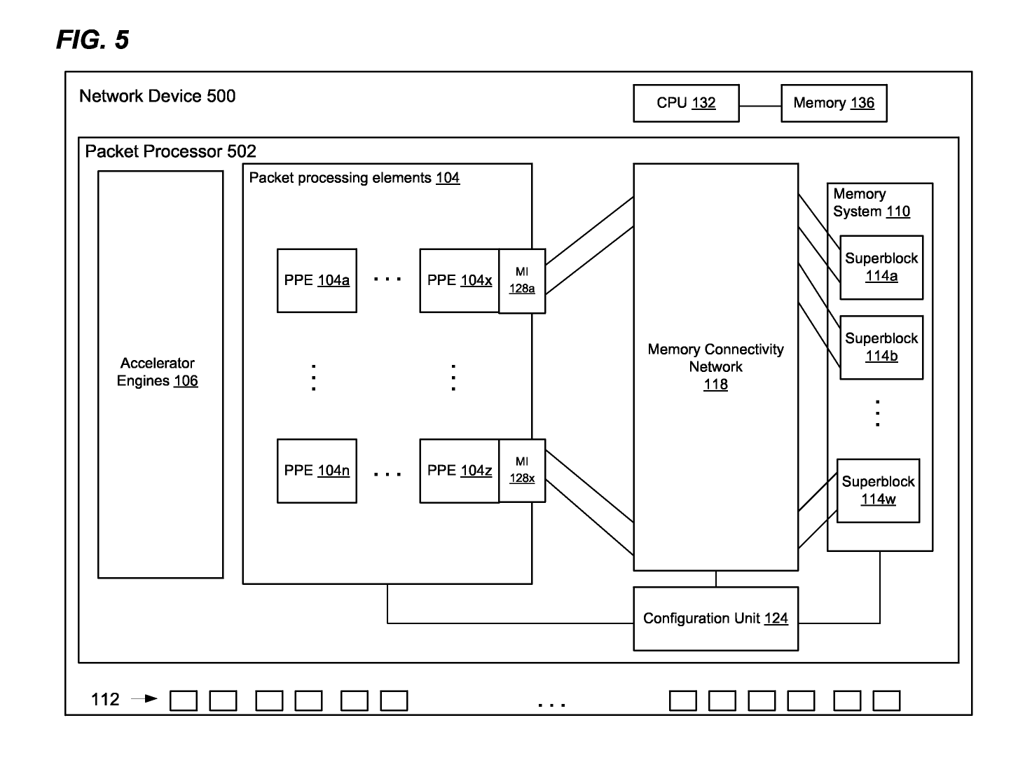

FIG. 5 is a block diagram of another example network device 500, according to another embodiment. The network device 500 is similar to the network device 100 of FIG. 1, except that the packet processing elements 104, rather than the accelerator engines 106, utilize the memory system 110, according to an embodiment.

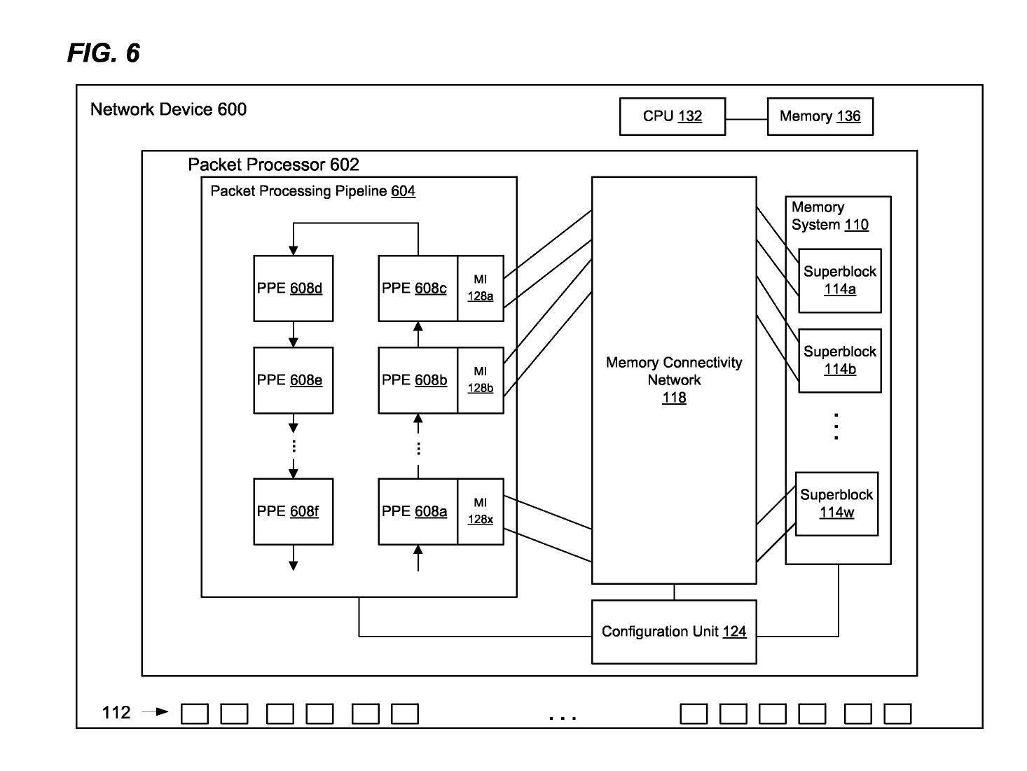

FIG. 6 is a block diagram of another example network device 600, according to another embodiment. The network device 600 is similar to the network device 100 of FIG. 1, except that a packet processor 602 included a packet processing pipeline 604 with pipelined processing elements 608, rather than the accelerator engines 106, that utilize the memory system 110, according to an embodiment.

In an embodiment, a network device comprises a plurality of processor devices configured to perform packet processing functions. The network device also comprises a shared memory system including a plurality of memory blocks, each memory block corresponding to a respective portion of the shared memory system, and each memory block having a respective size less than a total size of the shared memory system. The network device further comprises a memory connectivity network to couple the plurality of processor devices to the shared memory system, and a configuration unit to configure the memory connectivity network so that processor devices among the plurality of processor devices are provided access to respective sets of memory blocks among the plurality of memory blocks.

In other embodiments, the network device comprise any one of, or any combination of one or more of, the following features.

The memory connectivity network is configurable to connect multiple processor devices among the plurality of processor devices to multiple memory blocks among the plurality of memory blocks.

The memory connectivity network is configurable to connect each processor device among the plurality of processor devices to each memory block among the plurality of memory blocks.

The memory connectivity network comprises a hierarchical Clos network that includes a plurality of interconnected Clos sub-networks.

The memory connectivity network comprises a hierarchical Clos network that includes a plurality of first Clos sub-networks; a plurality of second Clos sub-networks, each second Clos sub-network having a respective output coupled to a respective first Clos sub-network; and a plurality of third Clos sub-networks, each third Clos sub-network having a respective input coupled to a respective first Clos sub-network.

The configuration unit assigns memory blocks among the plurality of memory blocks to processor devices among the plurality of processor devices.

The configuration unit assigns either i) multiple memory blocks among the plurality of memory blocks to a single processor device among the plurality of processor devices, or ii) a single memory block among the plurality of memory blocks to the single processor device based on memory requirements of the single processor device.

The configuration unit configures memory blocks among the plurality of memory blocks according to at least one of i) respective memory performance requirements of corresponding processor devices, or ii) respective memory size requirements of corresponding processor devices.

Memory blocks among the plurality of memory blocks are configured to perform respective power saving functions.

Memory blocks among the plurality of memory blocks are configured to gate respective clocks to respective portions of the memory blocks to reduce power consumption.

Memory blocks among the plurality of memory blocks are configured to shut off power to respective portions of the memory blocks to reduce power consumption.

Processor devices among the plurality of processor devices are configured to measure respective latencies between the processor devices and memory blocks among the plurality of memory blocks.

Memory blocks among the plurality of memory blocks include configurable delay lines; and the configuration unit configures the delay lines based on the measure latencies.

In another embodiment, a method includes determining memory requirements of a plurality of processor devices of a network device, the plurality of processors devices for performing packet processing functions on packets received from a network. The method also includes assigning, in the network device, memory blocks of a shared memory system to processor devices among the plurality of processor devices based on the determined memory requirements of respective processor devices, each memory block corresponding to a respective portion of the shared memory system, and each memory block having a respective size less than a total size of the shared memory system. Additionally, the method includes configuring, in the network device, a memory connectivity network that couples the plurality of processor devices to the shared memory system so that processor devices among the plurality of processor devices are provided access to respective assigned sets of memory blocks among the plurality of memory blocks.

In other embodiments, the method includes any one of, or any combination of one or more of, the following features.

Configuring the memory connectivity network comprises configuring a plurality of interconnected Clos sub-networks that form a hierarchical Clos network so that processor devices among the plurality of processor devices are provided access to respective assigned sets of memory blocks among the plurality of memory blocks via the interconnected Clos sub-networks.

Assigning memory blocks of the shared memory system comprises assigning either i) multiple memory blocks among the plurality of memory blocks to a single processor device among the plurality of processor devices, or ii) a single memory block among the plurality of memory blocks to the single processor device based on memory requirements of the single processor device.

The method further comprises configuring memory blocks among the plurality of memory blocks according to at least one of i) respective memory performance requirements of corresponding processor devices, or ii) respective memory size requirements of corresponding processor devices.

The method further comprises initializing memory interfaces in processor devices among the plurality of processor devices so that memory addresses generated by the processors devices are mapped to the memory blocks that are assigned to the processor devices.

The method further comprises measuring respective latencies between processor devices among the plurality of processor devices and memory blocks assigned to the processor devices.

The method further comprises configuring delay lines in the memory blocks based on the measured latencies.

The method further comprises configuring memory blocks among the plurality of memory blocks to gate respective clocks to respective portions of the memory blocks to reduce power consumption.

The method further comprises configuring memory blocks among the plurality of memory blocks to shut off power to respective portions of the memory blocks to reduce power consumption.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable medium or media such as a magnetic disk, an optical disk, a RAM or ROM or flash memory, etc. The software or firmware instructions may include machine readable instructions that, when executed by the processor, cause the processor to perform various acts.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

What is claimed is:

1. A network device, comprising:
a plurality of processor devices configured to perform packet processing functions;
a shared memory system including a plurality of memory blocks, each memory block corresponding to a respective portion of the shared memory system, and each memory block having a respective size less than a total size of the shared memory system; and
a memory connectivity network to couple the plurality of processor devices to the shared memory system; and
a configuration unit to configure the memory connectivity network so that processor devices among the plurality of processor devices are provided access to respective sets of memory blocks among the plurality of memory blocks.

2. The network device of claim 1, wherein the memory connectivity network is configurable to connect multiple processor devices among the plurality of processor devices to multiple memory blocks among the plurality of memory blocks.

3. The network device of claim 2, wherein the memory connectivity network is configurable to connect each processor device among the plurality of processor devices to each memory block among the plurality of memory blocks.

4. The network device of claim 1, wherein the memory connectivity network comprises a hierarchical Clos network that includes a plurality of interconnected Clos sub-networks.

5. The network device of claim 4, wherein the hierarchical Clos network comprises:
a plurality of first Clos sub-networks;
a plurality of second Clos sub-networks, each second Clos sub-network having a respective output coupled to a respective first Clos sub-network; and
a plurality of third Clos sub-networks, each third Clos sub-network having a respective input coupled to a respective first Clos sub-network.

6. The network device of claim 1, wherein the configuration unit assigns memory blocks among the plurality of memory blocks to processor devices among the plurality of processor devices.

7. The network device of claim 6, wherein the configuration unit assigns either i) multiple memory blocks among the plurality of memory blocks to a single processor device among the plurality of processor devices, or ii) a single memory block among the plurality of memory blocks to the single processor device based on memory requirements of the single processor device.

8. The switch device of claim 1, wherein the configuration unit configures memory blocks among the plurality of memory blocks according to at least one of i) respective memory performance requirements of corresponding processor devices, or ii) respective memory size requirements of corresponding processor devices.

9. The network device of claim 1, wherein memory blocks among the plurality of memory blocks are configured to perform respective power saving functions.

10. The network device of claim 9, wherein memory blocks among the plurality of memory blocks are configured to gate respective clocks to respective portions of the memory blocks to reduce power consumption.

11. The network device of claim 9, wherein memory blocks among the plurality of memory blocks are configured to shut off power to respective portions of the memory blocks to reduce power consumption.

12. The network device of claim 1, wherein processor devices among the plurality of processor devices are configured to measure respective latencies between the processor devices and memory blocks among the plurality of memory blocks.

13. The switch device of claim 12, wherein:
memory blocks among the plurality of memory blocks include configurable delay lines; and
the configuration unit configures the delay lines based on the measure latencies.

14. A method, comprising:
determining memory requirements of a plurality of processor devices of a network device, the plurality of processors devices for performing packet processing functions on packets received from a network;
assigning, in the network device, memory blocks of a shared memory system to processor devices among the plurality of processor devices based on the determined memory requirements of respective processor devices, each memory block corresponding to a respective portion of the shared memory system, and each memory block having a respective size less than a total size of the shared memory system; and
configuring, in the network device, a memory connectivity network that couples the plurality of processor devices to the shared memory system so that processor devices among the plurality of processor devices are provided access to respective assigned sets of memory blocks among the plurality of memory blocks.

15. The method of claim 14, wherein configuring the memory connectivity network comprises configuring a plurality of interconnected Clos sub-networks that form a hierarchical Clos network so that processor devices among the plurality of processor devices are provided access to respective assigned sets of memory blocks among the plurality of memory blocks via the interconnected Clos sub-networks.

16. The method of claim 14, wherein assigning memory blocks of the shared memory system comprises assigning either i) multiple memory blocks among the plurality of memory blocks to a single processor device among the plurality of processor devices, or ii) a single memory block among the plurality of memory blocks to the single processor device based on memory requirements of the single processor device.

17. The method of claim 14, further comprising configuring memory blocks among the plurality of memory blocks according to at least one of i) respective memory performance requirements of corresponding processor devices, or ii) respective memory size requirements of corresponding processor devices.

18. The method of claim 14, further comprising initializing memory interfaces in processor devices among the plurality of processor devices so that memory addresses generated by the processors devices are mapped to the memory blocks that are assigned to the processor devices.

19. The method of claim 14, further comprising measuring respective latencies between processor devices among the plurality of processor devices and memory blocks assigned to the processor devices.

20. The method of claim 19, further comprising configuring delay lines in the memory blocks based on the measured latencies.

21. The method of claim 14, further comprising configuring memory blocks among the plurality of memory blocks to gate respective clocks to respective portions of the memory blocks to reduce power consumption.

22. The method of claim 14, further comprising configuring memory blocks among the plurality of memory blocks to shut off power to respective portions of the memory blocks to reduce power consumption.
